(19) United States
(12) Patent Application Publication
(10) Pub. No.: US 2009/0068340 A1
(43) Pub. Date: Mar. 12, 2009

(54) Machine for Processing Printing Material and Method for Structuring the Printing Material

(75) Inventors: Gerd Junghans, Schwetzingen (DE); Robert Singer, Malsch (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/205,203

(22) Filed: Sep. 5, 2008

(30) Foreign Application Priority Data
Sep. 6, 2007 (DE) 102007042355.3

(51) Int. Cl. B05D 3/06; B05C 11/00; B05C 11/10

(52) U.S. Cl. 427/8; 118/46; 118/708; 427/555

(57) ABSTRACT

A machine for processing printing material has at least one processing unit in which a printing material is modified in terms of shape or by application of a printing ink onto its surface. The printing material includes a surface area which either carries an electrically conductive substance or to which an electrically conductive substance is applied by an application unit of the machine for processing printing material. The machine further has a laser treatment unit for structuring the electrically conductive substance located on the printing material by partial modification or removal of the electrically conductive substance by a focused laser beam. In a corresponding method of operating the machine, at least one focused laser beam structures the electrically conductive substance located on the printing material by partial modification or removal of the electrically conductive substance. Structures of less than 10 micrometers in size can be achieved.

### CROSS-REFERENCE TO RELATED APPLICATION

This application claims the priority, under 35 U.S.C. § 119, of German application DE 10 2007 042 355.3, filed Sep. 6, 2007; the prior application is herewith incorporated by reference in its entirety.

### BACKGROUND OF THE INVENTION

### Field of the Invention

The invention relates to a machine for processing printing material having at least one processing unit in which the printing material is modified in terms of shape or by applying a printing ink onto its surface. The printing material includes a surface area on which either an electrically conductive substance is present or onto which an electrically conductive substance is applied by an application unit of the machine for processing printing material. The invention furthermore relates to a method for operating the machine for processing printing material for structuring a surface area of the printing material on which either an electrically conductive substance is present or onto which an electrically conductive substance is applied by an application unit of the machine processing printing material. At least one processing unit of the machine for processing printing material modifies the printing material in terms of shape or by applying a printing ink onto its surface in the method.

Today, many printed products, in particular packaging or labels, are provided with data carriers such as electric circuits, for example radio frequency identification (RFID) tags, transponders, smart labels, memory elements, or chips as touch-free identifiers, for example to simplify logistics or to prevent crimes. In this context, efforts have been made to modify an electrically conductive substance on the printed product or printing material in a printing process in order to apply at least the antennae structures that are necessary for touch-free communication of the electric circuits with a read/readout device.

Ways to produce RFID labels in a printing process, in particular in a printing process using a printing plate (also referred to as a printing master) are described, for example, in international patent disclosure WO 2005/013189A2, corresponding to U.S. Patent Application Publication No. 2007/0039694 A1. Furthermore, published, non-prosecuted German patent application DE 10 2005 026 127 A1 discloses a sheet-fed printing press in which RFID transponders, in particular the antennae thereof, are applied to a printing material. In particular, the antennae are printed. One feature or characteristic of the RFID transponder, for example the shape of the electrically conductive paths, is examined in the machine, i.e. in line, just like the optical features of the entire printed product.

For certain applications, individualized electrical circuits are desirable, whereas multiplication processes such as a printing process using a printing master ideally produces identical copies. In accordance with one aspect of published, non-prosecuted German patent application DE 10 2005 002 150 A1, which describes the creation of memory elements in the form of printed sequences of conductive lines, create disruptions in the lines are created by mechanical, thermal, or preferably electrical devices. To simplify the disruption process, which is carried out by a read/write device applying a current, the individual lines have narrow points.

In typical printing processes, only structures of about 30 to 100 micrometers can be created in a reproducible way. The minimum structural size in offset printing, for example, is 20 micrometers. Consequently, only low frequencies of directly printed oscillating circuits can be achieved. Yet typical RFID applications require higher frequencies.

### SUMMARY OF THE INVENTION

It is accordingly an object of the invention to provide a machine for processing printing material and a method for structuring the printing material which overcome the above-mentioned disadvantages of the prior art methods and devices of this general type, which enhances and/or broadens the options in terms of printing technology for printing material provided with a surface area with an electrically conductive substance.

In accordance with the invention, a machine for processing printing material contains at least one processing unit in which a printing material is modified in terms of shape or by applying a printing ink to its surface. The printing material includes at least one surface area on which either an electrically conductive substance is present or onto which an electrically conductive substance is applied by an application unit of the machine processing printing material. The machine according to the invention also contains a laser treatment unit for structuring the electrically conductive substance on the printing material by at least partially modifying or removing the electrically conductive substance by use of at least one focused laser beam of a laser.

The invention allows to structure printable electrical circuits or electronics, in particular polymeric electronics, or to structure printed blanks (or precursors) of electronic circuits or electronics by a laser in the machine for processing printing material, i.e. in line, in particular by post-treatment by a laser. Printed electric circuits, electronics, in particular polymeric electronics, or the blanks thereof are post-treated by a laser which partially modifies or removes the printed electrically conductive substance to obtain a fine-structuring or individualization, for example for RFID applications.

The surface area may have an unstructured geometric shape with straight or curved edges, or it may already have a structure, for example recesses, separations into sections, or inclusions, which do not bear any electrically conductive substance. The surface area may be simply connected. The electrically conductive substance may already represent an electric circuit.

In specific embodiments, in particular in inkjet printing, the printing ink may be inkjet ink. The electrically conductive substance may be an electrically conductive printing ink. The electrically conductive substance may be an individual substance or a compound of several different substances. The electrically conductive substance may be present on the printing material in particular after the action of the processing unit. The partial modification or removal may occur in a location-dependent or position-dependent way within the surface area. The printing material may in particular be paper, cardboard, paperboard, or organic polymer foil. The machine processing printing material may be a print shop machine. The laser light may in particular have a wavelength in the infrared spectral range, preferably between 800 nm and 1600 nm.

The surface area(s) with the electrically conductive substance may in particular be only surface parts of a printed packaging or of a label.

In a particularly advantageous way, in accordance with the invention, a laser can achieve structural sizes of less than 10 micrometers, in particular less than 5 micrometers, more particularly between 5 micrometers and 1 micrometer. Thus it is possible to create much finer structures than using conventional printing technology.

In accordance with a particularly preferred embodiment, the laser of the laser treatment unit in the machine processing printing material can be positioned relative to the printing material. In particular, the position of the laser and/or the position of the surface area of the electrically conductive substance may be detectable by a position detection unit and may be controllable by a control unit. In other words, the machine of the invention for processing printing material contains a register control for the laser treatment unit so that in-register, in-line treatment of the printed electrically conductive substance, in particular of the printed electronics, can be carried out by the laser(s).

The printing material may be transported along a transport path through the machine of the invention processing printing material by at least one transport device, for example transport drums in the case of sheet-shaped printing material or transport rollers in the case of web-shaped printing material. The laser treatment unit may be provided downstream of the processing unit along a path through the machine processing printing material.

In a first group of embodiments of the invention, the laser treatment unit of the machine processing printing material may contain a plurality of laser modules that are movable in the lateral direction relative to the transport direction of the printing material through the machine processing printing material.

In a second group of embodiments, the laser treatment unit of the machine for processing printing material may include a plurality of lasers whose light beams impinge on the printing material over the full used width in the lateral direction. In accordance with a slight modification, a laser treatment unit may include an arrangement that allows the use of a maximum width for electrical circuits, this maximum width being different than the maximum width of the color print. A further element of this group of embodiments is an arrangement in which further lasers are available to the left and right of the default or nominal position for the treatment so that the position can be changed by selecting the lasers to be used.

In accordance with advantageously refined embodiments, the laser treatment unit of the invention may include an autofocus for adjusting the focus position of the at least one laser beam. In this way, it is possible to specifically achieve a modification or removal in the depth of the electrically conductive substance present on the printing material. In particular, this provision allows targeted structuring of multilayer systems of electrically conductive substances.

Moreover, the machine of the invention for processing printing material may have the following features: the laser treatment unit may contain a plurality of individually controllable lasers. The laser(s) may be diode lasers, diode laser bars, solid-state lasers, or fiber lasers. The at least one laser may be a single-mode laser or a multimode laser.

The application unit for the electrically conductive substance may be a printing unit or a varnishing unit so that in particular the electrically conductive substance may be applied directly to the printing material. Alternatively, the application unit may be a dispenser or a labeling device, in particular if the electrically conductive substance is on a carrier that is attached to the printing material. In other words, the electric circuits or electronics, in particular polymer electronics, may be printed within the machine processing printing material in which the laser treatment is carried out, or they may be printed in a different machine prior to the production process so that the blanks are introduced into the machine processing printing material in which the laser treatment is carried out.

The electrically conductive substance may be a thermally sensitive (conductive) polymer. The polymer may be an organic polymer. The electrically conductive substance may be printable. To put it differently, before the application, the substance may be paste-like, fluid, or liquid. Alternatively, the electrically conductive substance may be on a carrier substrate, for example a polyester foil, or on an electronic chip. The electronic chip may be produced conventionally.

A first class of machines for processing printing material is formed by printing presses. In other words, the machine for processing printing material may be a printing press. In particular, the printing press may be a sheet-fed printing press, a rotary printing press, a multicolor printing press, an offset printing press, a flexographic printing press, a gravure press, or a combination printing press. In specific embodiments, the printing press may include at least one printing unit which can be converted between different printing processes from the group including offset printing, flexographic printing, gravure, serigraphy, xerography, ink drop printing (drop-on-demand inkjet printing), and letterpress printing. The printing press may be suitable or optimized for printing packaging. The machine processing printing material, in particular the printing press, may be a label printing machine. The label printing machine may be a web-fed printing machine for processing narrow webs.

A second class of machines of the invention for processing printing material is formed of machines for further processing (post press machines, machines for the further processing of prints, bookbindery machines). In other words, the machine for processing printing material may be a machine for further processing. In particular, the machine for further processing may be a folding machine, a saddle stitcher, a perfect binder, a thread sealing machine, a die-cutting machine, a piling machine, or a folder-gluer.

The inventive idea also encompasses a method carried out in a machine for processing printing material. The method of the invention in a machine for processing printing material is used or suitable for structuring a surface area of a printing material on which either an electrically conductive substance is present or onto which an electrically conductive substance is applied by an application unit of the machine for processing printing material. In accordance with the method of the invention, a printing material is modified by at least one processing unit of the machine for processing printing material in terms of its shape or by application of a printing ink onto the surface of the printing material. At least one focused laser beam of a laser of a laser treatment unit of the machine for processing printing material structures the electrically conductive substance by at least partial modification or removal of the electrically conductive substance.

The method of the invention in the machine for processing printing material can be used to produce a fine structure with dimensions of less than 6 micrometers. By the method of the invention, an antenna for a RFID transponder can be created as a result of the structuring. In an analogous way, it is possible to create structures that represent capacitances, inductances, transistors, or other electronic circuit elements.

In specific embodiments of the method of the invention, a three-dimensional structuring is carried out in superposed layers of electrically conductive substances by adjusting the focus position of the laser beam. In an advantageous embodiment of the method of the invention, the position of the laser and/or the location of the surface area with the electrically conductive substance may be detected by a position detection unit and controlled by a control unit.

A specific embodiment of the method of the invention refers to an individualization of printed electronics, electrical circuits, or the blanks thereof. A control unit controls the laser treatment unit in such a way that mutually different structures are created on individual surface areas of a plurality of surface areas carrying the electrically conductive substance on the printing material. Thus individual surface areas on the printing material are individualized for individual printed products in an irreversible and/or no longer manipulable way. Laser light causes an irreversible and/or no longer manipulable individualization of electronic circuits on printed products. Thus for example individualized RFID transponders or labels can be produced. Electronic circuits can be personalized. It is possible to introduce information on the date, a parts number, a serial number, a lot number, or the like.

The features of the machine of the invention for processing printing material and of the method of the invention in a machine for processing printing material which have been described herein may be implemented individually and independently of each other or in combination.

Other features which are considered as characteristic for the invention are set forth in the appended claims.

Although the invention is illustrated and described herein as embodied in a machine for processing printing material and a method for structuring the printing material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic illustration of a sheet-fed printing press as an embodiment of a machine for processing printing material in accordance with the invention;

FIG. 2 is a diagrammatic elevational view of a laser treatment unit of the embodiment of the sheet-fed printing press illustrated in FIG. 1;

FIGS. 3A and 3B are illustrations showing a surface area carrying an electrically conductive substance before and after treatment by a laser; and

FIG. 4 is a diagrammatic, perspective view of a saddle stitcher as an alternative embodiment of the machine for processing printing material in accordance with the invention.

### DETAILED DESCRIPTION OF THE INVENTION

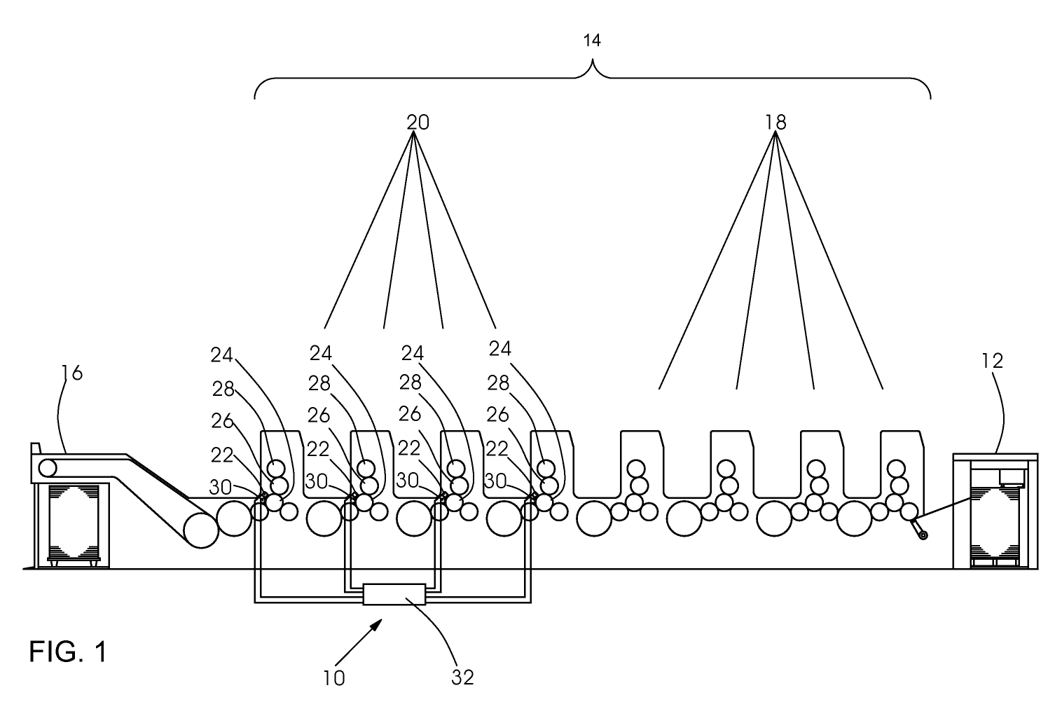

Referring now to the figures of the drawing in detail and first, particularly, to FIG. 1 thereof, there is shown a printing press, more precisely a sheet-fed printing press, as an embodiment of a machine 10 for processing printing material in accordance with the invention. The printing press 10 includes a feeder 12 for a stack of sheets of printing material. In the given example, the printing material is paperboard. The printing press 10 further contains a plurality of printing units 14 and a delivery 16. The four first printing units 14 are used as processing units 18 for printing four colors (the standard or process colors CMYK), for example to print packaging.

The four subsequent printing units 14 are used as application units 20. Each of these printing units 14 can apply a layer of an electrically conductive substance. The application may be based on a printing master or printing plate which is received on a plate cylinder 28 and is wetted with an electrically conductive substance. In a nip formed between a transfer cylinder 26 and an impression cylinder 24, the printed image of the electrically conductive substance is transferred to the printing material, which is transported on the impression cylinder 24. If the printing press 10 prints multiple copies (printed products per sheet) of packaging products onto one sheet, each copy is assigned at least one surface area carrying the electrically conductive substance. A laser treatment unit 22 whose laser light impinges on a sheet of printing material which is transported past the laser treatment unit 22 on the impression cylinder 24 is located downstream of each printing nip in the printing units 14 acting as an application unit 20. Once a layer of the electrically conductive substance has been applied, partial modification or removal may be carried out by the laser light that is focused on positions within the surface area. The partial modification or removal of the substance may be implemented by evaporation in surface parts of the surface area. In specific electrically conductive substances in the form of thermally sensitive polymers, the result of the thermal effect of the laser light may be that the electric properties of the polymer changes. In particular, the exposed areas of the polymer may become non-conductive, i.e. they may be turned into isolating areas. In a further application unit 20 following a first application unit 20, another layer of an electrically conductive substance may be applied onto the same surface area. The laser treatment unit 22 located downstream of the printing nip may then at least partly modify or remove this layer of the electrically conductive substance. Thus a multilayer, three-dimensional structure of an electrically conductive substance may be created on the printed product. In the example illustrated in FIG. 1, the structure has four layers. The individual application units 20 may apply different electrically conductive substances or the same electrically conductive substances to the printing material.

In typical applications of packaging or labels, printed electrical circuits generally only cover part of the surface that is to be printed with colored printing ink in a conventional process. For this reason, the laser treatment unit 22 may include a plurality of lasers, and the individual laser beams may be capable of being positioned in accordance with the arrangement of the printed electrical circuits, in accordance with the surface areas carrying an electrically conductive substance, in particular in accordance with the arrangement of the copies.

A position detection unit 30 is associated with each laser treatment unit 22. The position of the layers that have already been printed and/or the position of the treatment result of the laser exposure are detected. The position detection unit 30 may, for example, include a CCD array or a CMOS array as a sensor or detector. A control path is provided which can at least compensate for slow positional changes (slow as compared to the machine speed). The measured data are fed to a control unit 32. The control unit 32 activates the laser treatment units 22, in particular the positioning device of the laser treatment units 22, to provide a sufficient degree of register accuracy between the different layers of the electrically conductive substance and/or of the treatment patterns of the laser treatment unit 22. Furthermore, the process steps that have been carried out can be inspected. The register of the preceding color prints that have been carried out in the first four printing units 14 of the printing press 10 is likewise inspected and corrected if necessary.

As an alternative to the situation illustrated in FIG. 1 in which each application unit 20 is assigned a laser treatment unit 22 for the treatment or post-treatment of the layer applied in the application unit 20, another embodiment contains a laser treatment unit 22 in which a variation of the position of the focus of the laser beam(s) in the depth of a multilayer system is possible. Thus individual layers in the multilayer arrangement of electrically conductive substance layers can be treated individually without influencing layers above or below. An auto focus may be provided to adjust the focus position. Resolutions of ±20 micrometers are possible. Due to their low depth of sharpness, multimode lasers are particularly suited for such embodiments.

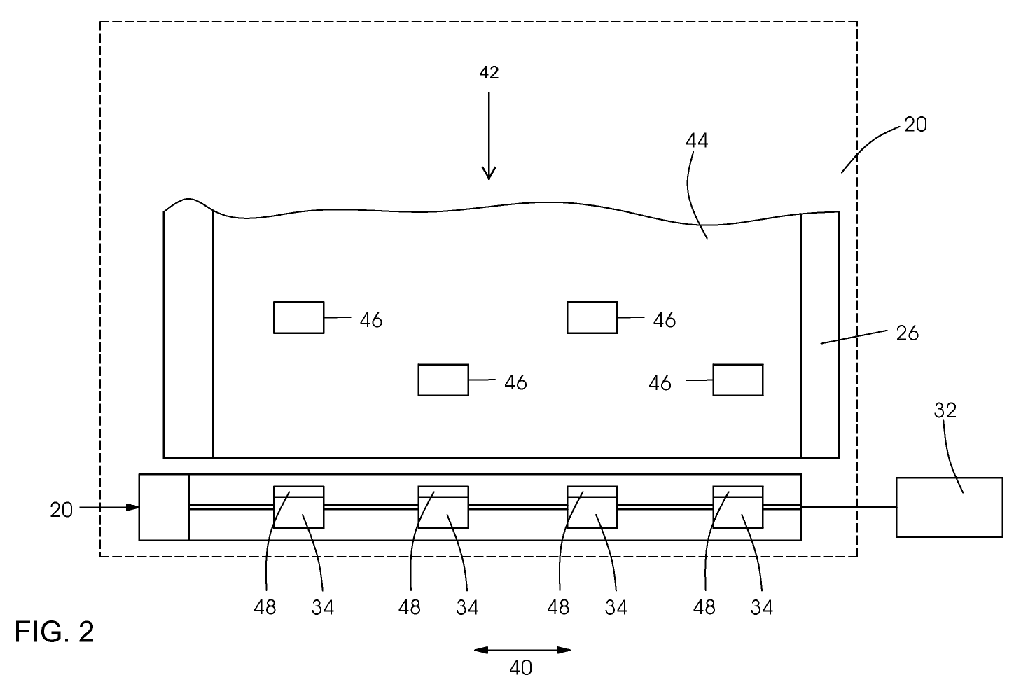

FIG. 2 is a diagrammatic elevational view of the laser treatment unit 22 of an application unit 20 of the embodiment of the printing press 10 for processing sheets of printing material as shown in FIG. 1. In this embodiment, the laser treatment unit 22 has four laser modules 34 mounted on a crossbar. The laser modules 34 are capable of being moved and positioned within certain limitations in a lateral direction 40, perpendicular to a direction of transport 42 of a printing material 44 through the printing press 10 individually and independently of each other by a drive unit 38 by a translational actuating system 36 such as spindles or linear motors. As explained above, the position of the printed electronics on the printing material 44 is detected by a sensor so that the position of the laser beam can be controlled by the control unit 32 to minimize or avoid register errors. FIG. 2 illustrates a sheet of printing material 44 being moved past the laser treatment unit 22 in a direction of transport 42 on an impression cylinder 26. Four surface areas 46 carrying an electrically conductive substance are printed on the printing material 44. These surface areas 46 are to be treated by the laser light emitted by the laser modules 34. The positions of the laser modules 34 are adapted to the respective positions of the surface areas 46, which are determined, for example, by the arrangement of the copies on the sheet. In this embodiment, each laser module 34 includes a laser diode bar 48 with individually controllable diode lasers as independent light sources. The image dots of the individual diode lasers of the laser diode bars 48 can be projected to the surface of the printing material 44 closely together in a row which is essentially parallel to the lateral direction 40.

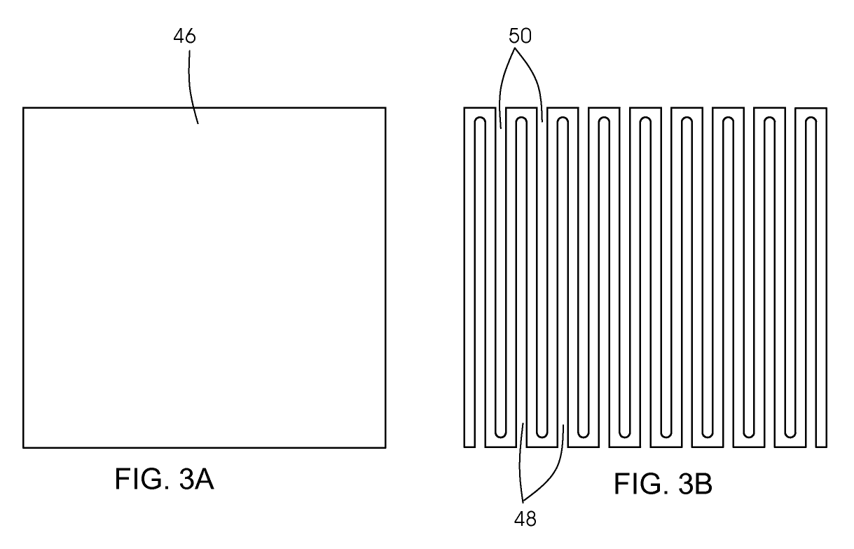

FIGS. 3A and 3B illustrate the surface area 46 carrying an electrically conductive substance. FIG. 3A illustrates the electrically conductive substance before any treatment by a laser in accordance with the invention. FIG. 3B illustrates the substance after the laser treatment in accordance with the invention. The invention allows post-treatment of a coarse printed structure to form a fine structure. For example, an oscillating circuit requires an inductivity that can conventionally be printed in the form of a meander-shaped conductive path. However, a two-dimensional print in accordance with the invention is much less demanding in terms of resolution and/or in terms of the printable electrically conductive substance. Thus a large surface area 46 (FIG. 3A) can be applied to the printing material. This large surface area 46 is then structured by the laser beam by forming recesses or indentations in the surface area 46 (FIG. 3B). Thus the method and device of the invention provide a way to produce a meander-shaped conductive path with finer structures than one created by direct printing.

It is also possible to adjust a capacitance, in particular of an oscillating circuit, for accurate individual adaptation by a laser treatment. On the one hand, the area of the electrodes of the capacitance can be adjusted more accurately by the method of the invention than by direct printing. On the other hand, it is also possible to create the electrodes of a capacitor with multiple subareas and to adjust the capacitance to an accurate value by cutting off subareas.

In the case of transistors or similar electronic components, the process may be analogous. An additional aspect in this context is the three-dimensional character resulting from superposed layers. The circuit can be versioned or personalized by selective severing of connections or selective destruction of individual cells.

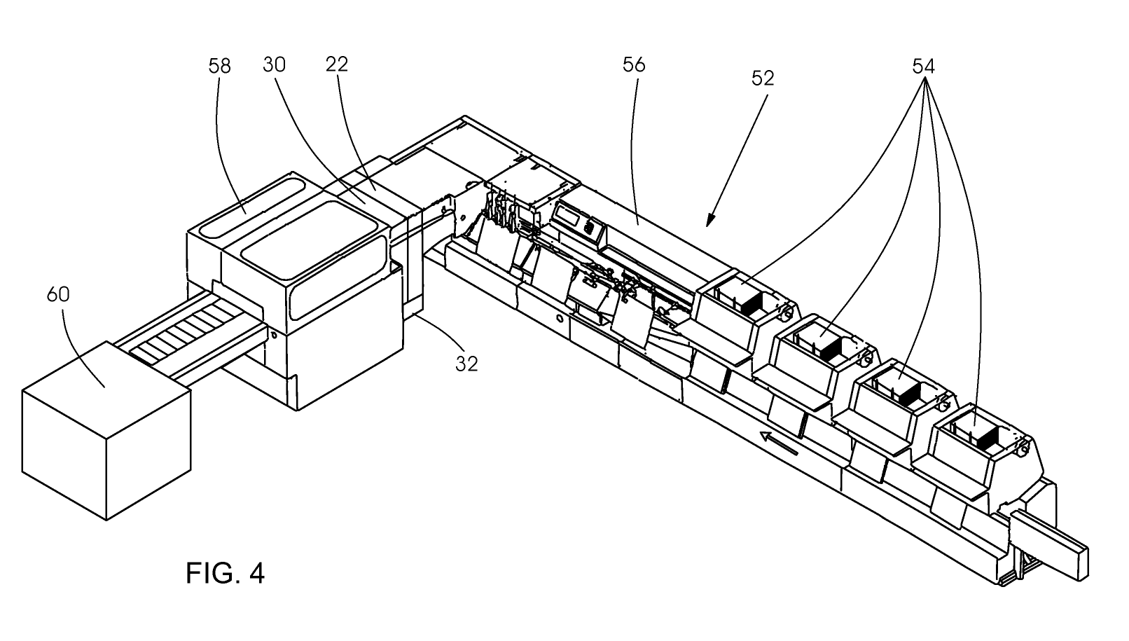

FIG. 4 diagrammatically illustrates an alternative embodiment of a machine of the invention for processing printing material. In this embodiment, the machine processing printing material is a saddle stitcher 52. In a saddle stitcher 52, which is a type of post-press equipment, a plurality of printed signatures are gathered, stitched, trimmed, and delivered in stacks or in a shingled stream to form a multi-page printed product, for example a brochure or a magazine. A plurality of signature feeders 54 feed individual signatures to a saddle chain so that the signatures straddle the saddle chain and are located on top of each other. The saddle chain transports the printed product, which consists of several pages placed inside each other, to a stitching station 56, in which the individual pages are connected to each other in a wire stitching process. Then a lifting blade lifts the printed products off the saddle chain and transfers them to a belt transport section which conveys the printed products to a trimmer 58 for trimming the edges of the printed products. The trimmed printed products finally reach a stack forming unit 60.

In accordance with the invention, the belt transport section of the saddle stitcher 52 contains the laser treatment unit 22 between the stitching station 52 and the trimmer 58, which in the embodiment of FIG. 4 are processing units of the machine processing printing material. A surface area 46 carrying an electrically conductive substance on the outer side of the jacket of the gathered and stitched printed product receives a fine structuring by laser light in accordance with the invention. Thus an information carrier can be produced on the outer side of the printed product in a way similar to a printed bar code or an RFID transponder. The saddle stitcher 52 furthermore includes a position detection unit 30, which is provided downstream of the laser treatment unit 22 and allows to measure positional deviations of the laser treatment unit 22 based on the detection of the treatment result on the printed product. The measured data are processed in a control unit 32, which controls the laser treatment unit 22 to influence the position of the laser beams emitted by the laser treatment unit in order to reduce or avoid register inaccuracies.

1. A machine for processing printing material, comprising:
at least one processing unit for one of modifying the printing material in terms of shape and applying a printing ink to a surface of the printing material;
an application unit, the printing material having a surface area on which an electrically conductive substance is present or onto which the electrically conductive substance is applied by said application unit; and
a laser treatment unit having a laser for structuring the electrically conductive substance on the printing material by at least one focused laser beam of said laser, the structuring being one of at least partial modification of the electrically conductive substance and removal of the electrically conductive substance.

2. The machine for processing printing material according to claim 1, wherein said laser of said laser treatment unit is capable of being positioned relative to the printing material.

3. The machine for processing printing material according to claim 2, further comprising:
a control unit; and
a position detection device, a position of at least one of said laser and a position of the surface area of the electrically conductive substance are detectable by said position detection device and controllable by said control unit.

4. The machine for processing printing material according to claim 1, further comprising at least one transport device for moving the printing material along a path through the machine for processing printing material.

5. The machine for processing printing material according to claim 1, wherein said laser treatment unit is disposed downstream of said processing unit along a path through the machine for processing printing material.

6. The machine for processing printing material according to claim 1, wherein said laser treatment unit includes a plurality of laser modules which are movable in a lateral direction to a transport direction of the printing material through the machine for processing printing material.

7. The machine for processing printing material according to claim 1, wherein said laser treatment unit includes a plurality of lasers having light beams impinging upon the printing material over a full used width in a lateral direction.

8. The machine for processing printing material according to claim 1, wherein said laser treatment unit includes an autofocus for adjusting a focus position of the at least one focused laser beam.

9. The machine for processing printing material according to claim 1, wherein said laser treatment unit includes a plurality of individually controllable lasers.

10. The machine for processing printing material according to claim 7, wherein said lasers are selected from the group consisting of diode lasers, diode laser bars, solid-state lasers, and fiber lasers.

11. The machine for processing printing material according to claim 1, wherein said laser is one of a single-mode laser and a multimode laser.

12. The machine for processing printing material according to claim 1, wherein said application unit is selected from the group consisting of a printing unit and a varnishing unit.

13. The machine for processing printing material according to claim 1, wherein said application unit is selected from the group consisting of a dispenser and a labeling device.

14. The machine for processing printing material according to claim 1, wherein the electrically conductive substance is a thermally sensitive polymer.

15. The machine for processing printing material according to claim 1, wherein the electrically conductive substance is printable.

16. The machine for processing printing material according to claim 1, wherein the electrically conductive substance is located on one of a carrier substrate and an electronic chip.

17. The machine for processing printing material according to claim 1, wherein the machine for processing printing material is a printing press.

18. The machine for processing printing material according to claim 17, wherein said printing press is selected from the group consisting of a sheet-fed printing press, a rotary printing press, a multi-color printing press, an offset printing press, a flexographic printing press, a gravure press, and a combination printing press.

19. The machine for processing printing material according to claim 17, wherein the printing press includes at least one printing unit which is convertible between at least two different printing processes, the printing processes being selected from the group consisting of offset printing, flexographic printing, gravure, serigraphy, xerography, ink-drop printing, drop-on-demand inkjet printing, and letterpress printing.

20. The machine for processing printing material according to claim 1, wherein the machine for processing printing material is a label printing machine.

21. The machine for processing printing material according to claim 20, wherein the label printing machine is a web-fed printing machine for processing narrow webs.

22. The machine for processing printing material according to claim 1, wherein the machine for processing printing material is a machine for further processing.

23. The machine for processing printing material according to claim 22, wherein the machine for further processing is selected from the group consisting of a folding machine, a saddle stitcher, a perfect binder, a thread-sealing machine, and a folder-gluer.

24. A method for structuring a surface area of a printing material, which comprises the steps of:
performing one of supplying the printing material already having an electrically conductive substance and applying an electrically conductive substance to the printing material using an application unit of a machine for processing the printing material;
performing one of modifying the printing material in terms of shape and applying a printing ink onto a surface of the printing material by at least one processing unit of the machine for processing printing material; and
structuring the electrically conductive substance located on the printing material by one of at least partial modification of the electrically conductive substance and removal of the electrically conductive substance using at least one focused laser beam of a laser of a laser treatment unit of the machine processing printing material.

25. The method according to claim 24, which further comprises creating a fine structure having dimensions of less than 6 micrometers.

26. The method according to claim 24, which further comprises forming an antenna for an RFID transponder during the structuring step.

27. The method according to claim 24, which further comprises forming one of a capacitance, an inductance and a transistor during the structuring step.

28. The method according to claim 24, which further comprises carrying out a three-dimensional structuring in superposed layers of the electrically conductive substance by adjusting a focus position of the focused laser beam.

29. The method according to claim 24, which further comprises detecting at least one of a position of the laser and a position of a surface area carrying the electrically conductive substance with a position detection unit (30) controlled by a control unit.

30. The method according to claim 29, wherein the control unit controls the laser treatment unit such that different structures are created on individual surface areas of a plurality of surface areas carrying the electrically conductive substance on the printing material so as to cause at least one of an irreversible and no longer manipulable individualization of individual surface areas on the printing material for individual printed products.
